(19) United States
(12) Patent Application Publication
(10) Pub. No.: US 2022/0301086 A1
(43) Pub. Date: Sep. 22, 2022

(54) CONTROL METHOD, DEVICE, AND RECORDING MEDIUM

(71) Applicant: Panasonic Intellectual Property Corporation of America, Torrance, CA (US)

(72) Inventors: Yuji UNAGAMI, Osaka (JP); Junji MICHIYAMA, Fukuoka (JP); Junichiro SOEDA, Nara (JP); Motoji OHMORI, Osaka (JP); Tetsuji FUCHIKAMI, Osaka (JP); Yuuki HIROSE, Osaka (JP); Naohisa NISHIDA, Osaka (JP); Masahiro TAGUCHI, Osaka (JP)

(21) Appl. No.: 17/835,197

(22) Filed: Jun. 8, 2022

Related U.S. Application Data
(63) Continuation of application No. PCT/JP2020/046399, filed on Dec. 11, 2020.
(60) Provisional application No. 62/950,545, filed on Dec. 19, 2019.

(51) Int. Cl. G06Q 50/18

(52) U.S. Cl. CPC G06Q 50/18

(57) ABSTRACT

A control method includes: obtaining first transaction data that includes first information on a first contract made between a first user and a second user; storing the first transaction data obtained into the distributed ledger; obtaining second transaction data that includes second information on a second contract made between the first user and a third user; storing the second transaction data obtained into the distributed ledger; obtaining third transaction data using the first information and the second information, when one of the first transaction data and the second transaction data is associated with a remaining one of the first transaction data and the second transaction data, the third transaction data including third information on a third contract made between the second user and the third user; and storing the third transaction data obtained into the distributed ledger.

### CROSS REFERENCE TO RELATED APPLICATIONS

This is a continuation application of PCT International Application No. PCT/JP2020/046399 filed on Dec. 11, 2020, designating the United States of America, which is based on and claims priority of U.S. Provisional Patent Application No. 62/950,545 filed on Dec. 19, 2019. The entire disclosures of the above-identified applications, including the specifications, drawings and claims are incorporated herein by reference in their entirety.

### FIELD

The present disclosure relates to a control method, a device, and a recording medium.

### BACKGROUND

There is a technology for managing information on contracts, using distributed ledgers. Information stored in distributed ledgers is managed so as to be substantially unable to be rewritten.

A technology of using the same operating policy and making the operating timings coincide even in a situation in which a plurality of managers are present in a system in which distributed ledgers are used has been disclosed.

### CITATION LIST

### Patent Literature

PTL 1: WO No. 2019/021792

### SUMMARY

### Technical Problem

The present disclosure provides, for instance, a control method for reducing an increase in power consumption of a computer system that manages contracts.

### Solution to Problem

A control method according to an aspect of the present disclosure is a control method executed by a device out of a plurality of devices each having a distributed ledger in a contract management system that includes the plurality of devices, the control method including: obtaining first transaction data that includes first information on a first contract made between a first user and a second user; storing the first transaction data obtained into the distributed ledger; obtaining second transaction data that includes second information on a second contract made between the first user and a third user; storing the second transaction data obtained into the distributed ledger; obtaining third transaction data using the first information and the second information, when one of the first transaction data and the second transaction data is associated with a remaining one of the first transaction data and the second transaction data, the third transaction data including third information on a third contract made between the second user and the third user; and storing the third transaction data obtained into the distributed ledger.

Note that these general and specific aspects may be implemented using a system, a device, an integrated circuit, a computer program, a computer-readable recording medium such as a CD-ROM, or any combination of systems, devices, integrated circuits, computer programs, or recording media.

### Advantageous Effects

The control method according to the present disclosure can reduce an increase in power consumption of a computer system that manages contracts.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is an explanatory drawing schematically illustrating examples of flows of contracts in Embodiment 1.

FIG. 2 is a block diagram schematically illustrating a configuration of a contract management system in Embodiment 1.

FIG. 3 is a block diagram illustrating a functional configuration of a ledger server in Embodiment 1.

FIG. 4 is an explanatory drawing illustrating a first example of transaction data in Embodiment 1.

FIG. 5 is an explanatory drawing illustrating a second example of transaction data in Embodiment 1.

FIG. 6 is an explanatory drawing illustrating a third example of transaction data in Embodiment 1.

FIG. 7 is a flowchart illustrating processing performed by a transaction server in Embodiment 1.

FIG. 8 is a first sequence diagram illustrating processing in a contract management system in Embodiment 1.

FIG. 9 is the first sequence diagram illustrating processing in the contract management system in Embodiment 1.

FIG. 10 is a block diagram schematically illustrating a configuration of a contract management system in Embodiment 2.

FIG. 11 is an explanatory drawing illustrating a first example of transaction data in Embodiment 2.

FIG. 12 is an explanatory drawing illustrating a second example of transaction data in Embodiment 2.

FIG. 13 is a sequence diagram illustrating processing in the contract management system in Embodiment 2.

FIG. 14 is a block diagram schematically illustrating a configuration of a contract management system in Variation 1.

FIG. 15 is a block diagram schematically illustrating a configuration of a contract management system in Variation 2.

FIG. 16 is an explanatory drawing illustrating a data structure of a blockchain.

FIG. 17 is an explanatory drawing illustrating a data structure of transaction data.

### DESCRIPTION OF EMBODIMENTS

### (Underlying Knowledge Forming Basis of the Present Disclosure)

The inventors have found that the technology related to contracts mentioned in the “Background” section has problems as below.

There is a technology for managing information on contracts, using distributed ledgers. Information stored in distributed ledgers is managed so as to be substantially unable to be rewritten. In addition, there has been a technology for executing processing related to a contract using distributed ledgers and managing the contract. Such a technology can be implemented with use of a smart contract, for example.

There are cases where a plurality of contracts having related contents are sequentially made. For example, there is a case in which after the contents of two contents are determined, the content of the third contract can be determined using the determined contents of the two contents.

When contracts made in such a manner are managed using distributed ledgers, it is assumed that the contents of two earlier contracts are stored into the distributed ledgers first, and thereafter the content of the new third contract is determined and stored into the distributed ledgers.

If the content of the new contract is determined and managed using distributed ledgers by a person, processing of presenting information to a person and receiving input of information from a person will be necessary, and power consumption of a computer used for the processing increases, which is a problem. In addition, there is a problem that more computer resources, such as, for example, an output device for presenting information (such as a display device or a loudspeaker) and a device for receiving input of information (such as a touch panel, a keyboard, or a mouse), are necessary for the processing.

Furthermore, there is a problem that a person is involved so that manpower is required. Moreover, a problem may arise that a person accidentally generates and stores incorrect content of a contract into distributed ledgers.

The present disclosure provides, for instance, a control method for reducing an increase in power consumption of a computer system that manages contracts.

A control method according to an aspect of the present disclosure is a control method executed by a device out of a plurality of devices each having a distributed ledger in a contract management system that includes the plurality of devices, the control method including: obtaining first transaction data that includes first information on a first contract made between a first user and a second user; storing the first transaction data obtained into the distributed ledger; obtaining second transaction data that includes second information on a second contract made between the first user and a third user; storing the second transaction data obtained into the distributed ledger; obtaining third transaction data using the first information and the second information, when one of the first transaction data and the second transaction data is associated with a remaining one of the first transaction data and the second transaction data, the third transaction data including third information on a third contract made between the second user and the third user; and storing the third transaction data obtained into the distributed ledger.

According to the above aspect, after transaction data items (specifically, the first transaction data and the second transaction data) for two contracts, that is, the first contract and the second contract are stored into the distributed ledger, transaction data (specifically, the third transaction data) for a new contract having content based on the contents of the above two contracts is generated and stored into the distributed ledger. Here, processing of generating and storing transaction data for a new contract into the distributed ledger is executed by computer processing in the device, or in other words, without a person being involved. Thus, an increase in power consumption of a computer can be reduced, and a necessary number of computer resources can be reduced. Furthermore, labor required if a person performs processing can be decreased. Accordingly, the control method can reduce an increase in power consumption of a computer system that manages contracts.

In obtaining the third transaction data, whether a condition is satisfied may be determined, the condition indicating that one of the first transaction data and the second transaction data is associated with a remaining one of the first transaction data and the second transaction data, and when the condition is determined to be satisfied, the third transaction data may be obtained by being generated.

According to the above aspect, the determination is made using a condition that one of the transaction data items for the two contracts that are the first contract and the second contract is associated with a remaining one of the transaction data items. Accordingly, it is further readily determined that one of the transaction data items is associated with a remaining one of the transaction data items, and transaction data for a new contract is generated and stored into the distributed ledger.

Accordingly, the control method can reduce an increase in power consumption of a computer system that manages contracts.

The second transaction data may include association information indicating that the second transaction data is associated with the first transaction data, and in determining whether the condition is satisfied, the condition may be a condition that the second transaction data includes the association information.

According to the above aspect, it is determined that one of the transaction data items for the two contracts is associated with a remaining one of the transaction data items, using the association information indicating that the second transaction data is associated with the first transaction data. Accordingly, it is further readily determined that one of the transaction data items is associated with a remaining one of the transaction data items, and transaction data for a new contract is generated and stored into the distributed ledger. Accordingly, the control method can reduce an increase in power consumption of a computer system that manages contracts.

In obtaining the third transaction data, the third transaction data may be obtained based on information designated by the first user, the first user being a contractor of the first contract and a contractor of the second contract.

According to the above aspect, the transaction data for the new contract is generated based on information designated by a contractor of both of the first contract and the second contract. Thus, transaction data for the new contract can be further readily generated.

The first transaction data may include first contract code that includes the first information.

According to the above aspect, the first contract is managed by a smart contract, or in other words, is managed without a person being involved. Thus, an increase in power consumption of a computer can be further reduced, and a necessary number of computer resources can be further reduced. In addition, labor required if a person performs processing can be further decreased. Accordingly, the control method can further reduce an increase in power consumption of a computer system that manages contracts.

The second transaction data may include second contract code that includes the second information.

According to the above aspect, the second contract is managed by a smart contract, or in other words, is managed without a person being involved. Thus, an increase in power consumption of a computer can be further reduced, and a necessary number of computer resources can be further reduced. In addition, labor required if a person performs processing can be further decreased. Accordingly, the control method can further reduce an increase in power consumption of a computer system that manages contracts.

The third transaction data may include third contract code that includes the third information.

According to the above aspect, the third contract is managed by a smart contract, or in other words, is managed without a person being involved. Thus, an increase in power consumption of a computer can be further reduced, and a necessary number of computer resources can be further reduced. In addition, labor required if a person performs processing can be further decreased. Accordingly, the control method can further reduce an increase in power consumption of a computer system that manages contracts.

The first transaction data may include a digital signature of the first user and a digital signature of the second user, and in storing the first transaction data into the distributed ledger, the first transaction data may be stored into the distributed ledger when the digital signature of the first user and the digital signature of the second user that are included in the first transaction data are both successfully verified.

According to the above aspect, the first transaction data for the first contract includes digital signatures of the first user and the second user who have made the first contract. Thus, it can be proved by verifying the digital signatures that the first user and the second user have certainly made the first contract. Accordingly, the above control method can further appropriately manage contracts.

The second transaction data may include a digital signature of the first user and a digital signature of the third user, and in storing the second transaction data into the distributed ledger, the second transaction data may be stored into the distributed ledger when the digital signature of the first user and the digital signature of the third user that are included in the second transaction data are both successfully verified.

According to the above aspect, the second transaction data for the second contract includes digital signatures of the first user and the third user who have made the second contract. Thus, it can be proved by verifying the digital signatures that the first user and the third user have certainly made the second contract. Accordingly, the above control method can further appropriately manage contracts.

The third transaction data may include a digital signature of a generation user who has generated the third transaction data, a digital signature of the second user, and a digital signature of the third user, and in storing the third transaction data into the distributed ledger, the third transaction data may be stored into the distributed ledger when the digital signature of the generation user, the digital signature of the second user, and the digital signature of the third user that are included in the third transaction data are all successfully verified.

According to the above aspect, the third transaction data for the third contract includes the digital signature of the generation user who has generated transaction data for the third contract and the digital signatures of the second user and the third user who have made the third contract. Accordingly, it can be proved by verifying the digital signatures that the generation user has certainly generated the transaction data for the third contract, and the second user and the third user have certainly made the third contract. Accordingly, the above control method can further appropriately manage contracts.

The first contract may include a contract that stipulates that the first user is to purchase material from the second user, the first information may include a purchase price of the material, the second contract may include a contract that stipulates that the third user is to manufacture a product from the material delivered from the second user, and deliver the product to the first user, the second information may include a purchase price of the product, a deadline by which the product is to be delivered, and a delivery destination of the product, the third contract may include a contract that stipulates that the second user is to deliver the material to the third user, and the third information may include a deadline by which the material is to be delivered and a delivery destination of the material.

According to the above aspect, the material delivery contract related to the delivery of the material, which is made between the material delivery source and the material delivery destination, is appropriately managed based on the material contract and the manufacturing contract. Thus, with the above control method, the material delivery contract made between the second user and the third user can be appropriately managed based on the material contract made between the first user and the second user and the manufacturing contract made between the first user and the third user.

A device according to an aspect of the present disclosure is a device out of a plurality of devices each having a distributed ledger in a contract management system that includes the plurality of devices, the device including: a processor; a ledger storage that stores therein the distributed ledger; and an executor. The processor: obtains first transaction data that includes first information on a first contract made between a first user and a second user; stores the first transaction data obtained into the distributed ledger; obtains second transaction data that includes second information on a second contract made between the first user and a third user; and stores the second transaction data obtained into the distributed ledger. The executor generates third transaction data using the first information and the second information, when one of the first transaction data and the second transaction data is associated with a remaining one of the first transaction data and the second transaction data, the third transaction data including third information on a third contract made between the second user and the third user, and the processor further stores the third transaction data generated into the distributed ledger.

According to the above aspect, advantageous effects similar to those achieved by the above control method can be yielded.

A recording medium according to an aspect of the present disclosure is a non-transitory computer-readable recording medium having recorded thereon a program for causing a computer to execute the control method as described above.

According to the above aspect, advantageous effects similar to those achieved by the above control method can be yielded.

Note that these general and specific aspects may be implemented using a system, a device, an integrated circuit, a computer program, a computer-readable recording medium such as a CD-ROM, or any combination of systems, devices, integrated circuits, computer programs, or recording media.

The following specifically describes embodiments with reference to the drawings.

Note that the embodiments described below each show a general or specific example. The numerical values, shapes, materials, elements, the arrangement and connection of the elements, steps, the processing order of the steps, and others indicated in the following embodiments are mere examples, and therefore are not intended to limit the present disclosure. Further, among the elements in the following embodiments, elements not recited in any independent claim defining the most generic concept are described as arbitrary elements.

### Embodiment 1

The present embodiment describes, for instance, a contract management system that reduces an increase in power consumption of a computer system that manages contracts and a control method of the contract management system.

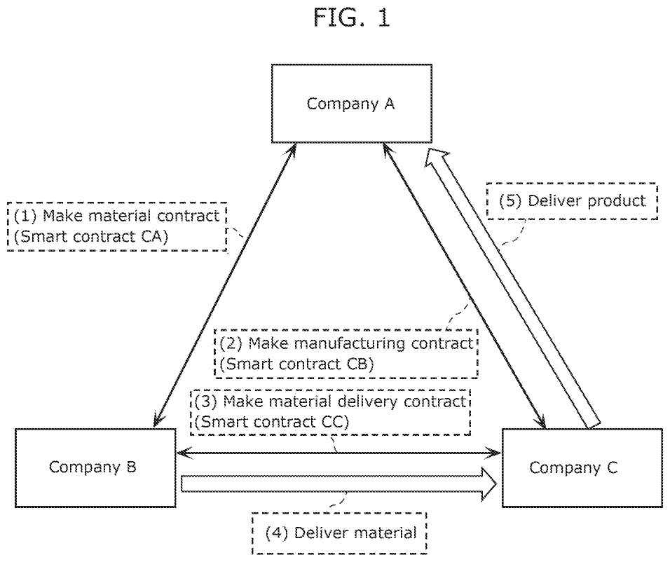

FIG. 1 is an explanatory drawing schematically illustrating examples of flows of contracts in the present embodiment.

Specifically, FIG. 1 schematically illustrates contracts in which three parties, company A, company B, and company C that constitute a supply chain are involved, and delivery of items under the contracts. Company A is also referred to as a first user, company B is also referred to as a second user, and company C is also referred to as a third user.

First, company A and company B make a material contract (corresponding to a first contract) as shown by (1) of FIG. 1. The material contract stipulates that company A is to purchase material from company B. The material contract includes a purchase price of the material.

After the material contract is made, company A and company C make a manufacturing contract (corresponding to a second contract) as shown by (2) in FIG. 1. The manufacturing contract is a contract that stipulates that company C is to manufacture a product from material, and deliver the manufactured product to company A. The manufacturing contract includes a delivery date of the product, a purchase price of the product, and a delivery destination of the product (also referred to as a product delivery destination).

After the manufacturing contract is made, company B and company C make a material delivery contract (corresponding to a third contract) as shown by (3) in FIG. 1. The material delivery contract stipulates that company B is to deliver the material to company C. The material delivery contract includes the delivery date of the material and the delivery destination of the material (also referred to as a material delivery destination).

After that, company B fulfills the material delivery contract by delivering the manufactured material to company C ((4) in FIG. 1). Company C manufactures the product from the material delivered from company B, and delivers the manufactured product to company A, thus fulfilling the manufacturing contract ((5) in FIG. 1).

To execute such processing related to contracts and fulfillment of the contracts using distributed ledgers, it is assumed that one smart contract CA that stipulates content of the material contract, one smart contract CB that stipulates content of the manufacturing contract, and one smart contract CC that stipulates content of the material delivery contract are used.

In this case, the content of smart contract CC can be generated using the contents of smart contracts CA and CB automatically, that is, without a person being involved.

By doing so, the above problems of an increase in power consumption of a computer and necessity of more devices can be avoided, and also a problem caused by a person being involved can be avoided.

Note that smart contracts CA, CB, and CC have at least a function of managing contents of the material contract, the manufacturing contract, and the material delivery contract, and may further have a function of performing processing related to fulfillment of contracts (for example, manufacture of material or a product, delivery of the manufactured material or product, and payment of the price, for instance).

The following describes in detail technology for appropriately managing such contracts.

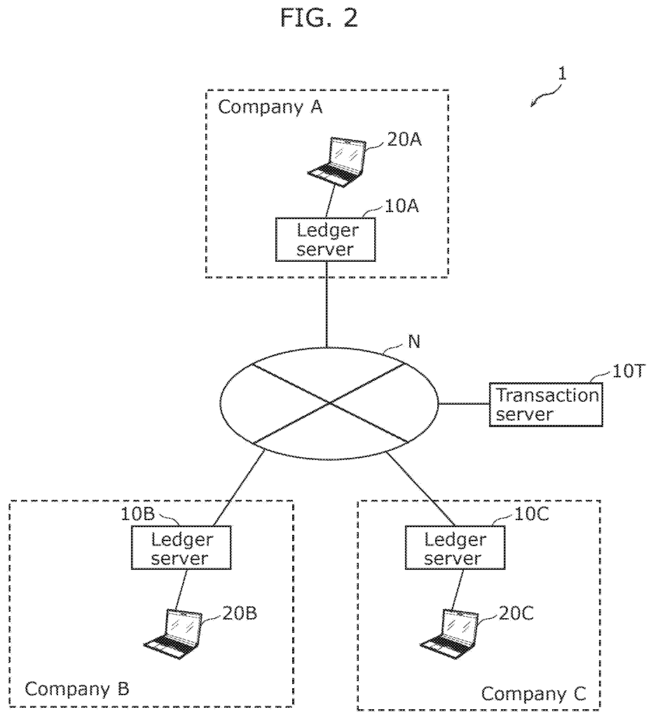

FIG. 2 is a block diagram schematically illustrating a configuration of contract management system 1 in the present embodiment.

As illustrated in FIG. 2, contract management system 1 includes ledger servers 10A, 10B, and 10C, transaction server 10T, and terminals 20A, 20B, and 20C.

Ledger servers 10A, 10B, and 10C are also referred to as “ledger servers 10A to 10C”, and terminals 20A, 20B and 20C are also referred to as “terminals 20A to 20C”.

Ledger server 10A and terminal 20A belong to company A, ledger server 10B and terminal 20B belong to company B, and ledger server 10C and terminal 20C belong to company C. Here, an example in which contract management system 1 manages contracts in which three parties are involved is shown, but nevertheless the number of parties involved in contracts may be four or more.

The devices included in contract management system 1 are directly or indirectly connected to network N, and can communicate with one another via network N.

Network N may include any communication line or network, and may include, for example, the Internet, a mobile phone carrier network, an access network of an Internet provider, or a public access network.

Ledger server 10A is one of ledger servers 10A to 10C that manage contracts using distributed ledgers in contract management system 1. Ledger server 10A may also be referred to as a device.

Ledger server 10A has a distributed ledger. The distributed ledger that ledger server 10A has stores therein transaction data. The transaction data stored in the distributed ledger includes transaction data that includes contract code (also simply referred to as code) for a smart contract related to a contract. Ledger server 10A includes a rewritable storage region other than a storage region in which the distributed ledger is stored, and stores a variable related to a contract into the rewritable storage region.

Ledger servers 10B and 10C are devices having the same function as ledger server 10A, and operate independently from ledger server 10A.

Transaction server 10T is a device that has a distributed ledger similarly to ledger servers 10A to 10C. Transaction server 10T stores transaction data into the distributed ledger, similarly to ledger servers 10A to 10C. Transaction server 10T includes a rewritable storage region other than a storage region in which the distributed ledger is stored, and stores variables related to a contract into the rewritable storage region. Further, transaction server 10T generates and stores a new smart contract into the distributed ledger, based on the transaction data stored into the distributed ledger. Transaction server 10T is connected directly or indirectly to network N, and can communicate with ledger servers 10A to 10C via network N.

Terminal 20A is an information terminal that a user belonging to company A uses. Terminal 20A is operated by the user, and is used to generate code for a smart contract and to put the code for the smart contract in ledger servers 10A to 10C, for example. Terminal 20A is, for example, a personal computer, a smartphone, or a tablet terminal.

Terminals 20B and 20C each have the same function as terminal 20A, are information terminals used by a user belonging to company B and a user belonging to company C, respectively, and operate independently from terminal 20A.

Note that company A, company B, and company C may each own one or more terminals.

Note that terminal 20A may further have functions of ledger server 10A. In that case, terminal 20A corresponds to a device that manages a contract using a distributed ledger. Similarly, terminal 20B may further have functions of ledger server 10B. In that case, terminal 20B corresponds to a device that manages a contract using a distributed ledger. Moreover, terminal 20C may further have functions of ledger server 10C. In that case, terminal 20C corresponds to a device that manages a contract using a distributed ledger.

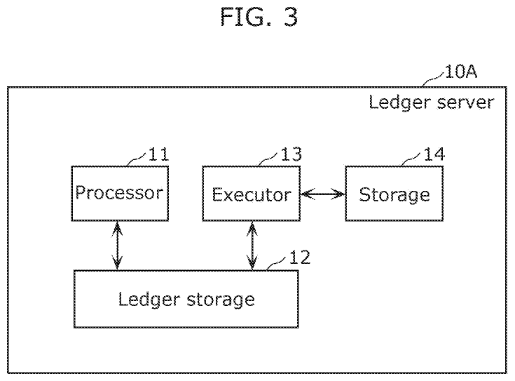

FIG. 3 is a block diagram illustrating a functional configuration of ledger server 10A in the present embodiment.

As illustrated in FIG. 3, ledger server 10A includes processor 11, ledger storage 12, executor 13, and storage 14. Note that ledger servers 10B and 10C and transaction server 10T also have equivalent functional units to those of ledger server 10A.

Processor 11 is a functional unit that executes processing related to transaction data. Processor 11 can be acquired by a processing unit (for example, a central processing unit (CPU)) included in ledger server 10A executing a program using a memory.

Processor 11 executes processing of obtaining transaction data, and storing the obtained transaction data into the distributed ledger. Further, processor 11 executes processing of generating transaction data, generating a digital signature (also simply referred to as a signature) for the generated transaction data, and giving the generated signature to the transaction data.

In storing new transaction data into the distributed ledger, processor 11 stores the new transaction data into ledger storage 12 in the form according to the type of the distributed ledger. Processor 11 transmits communication data to and receives communication data from ledger storage 12 that is included in another ledger server out of ledger servers 10A to 10C, and causes ledger storage 12 included in the other ledger server to also store the transaction data. For example, when the distributed ledger is a blockchain, processor 11 generates a block that includes new transaction data, and stores the block into ledger storage 12 after ledger servers 10A to 10C reach agreement on the generated block by consensus algorithm.

Specifically, processor 11 obtains first transaction data, and stores the obtained first transaction data into the distributed ledger. The first transaction data includes information (also referred to as first information) on a material contract (that is, the first contract) made between company A and company B.

Further, processor 11 obtains second transaction data, and stores the obtained second transaction data into the distributed ledger. The second transaction data includes information (also referred to as second information) on a manufacturing contract (that is, the second contract) made between company A and company C.

Further, processor 11 obtains third transaction data, and stores the obtained third transaction data into the distributed ledger. The third transaction data includes information (also referred to as third information) on a material delivery contract (that is, the third contract) made between company B and company C.

The third transaction data is generated by processor 11 of transaction server 10T and transmitted to ledger servers 10A to 10C, for example. In this case, processor 11 of transaction server 10T obtains the third transaction data by generating the data in the above manner. Processors 11 of ledger servers 10A to 10C may each obtain the third transaction data by receiving the data generated and transmitted by transaction server 10T.

Specifically, processor 11 of transaction server 10T generates third transaction data using the first information and the second information, when one of the first transaction data and the second transaction data is associated with a remaining one of the first transaction data and the second transaction data, the third transaction data including third information on a third contract made between the second user and the third user.

Here, in obtaining the third transaction data, processor 11 of transaction server 10T may determine whether a condition is satisfied, the condition indicating that one of the first transaction data and the second transaction data is associated with a remaining one of the first transaction data and the second transaction data, and may obtain the third transaction data by generating the third transaction data when the condition is determined to be satisfied.

More specifically, the second transaction data may include association information indicating that the second transaction data is associated with the first transaction data. In determining whether the condition is satisfied, processor 11 may make the determination based on a condition that the second transaction data includes the association information.

Ledger storage 12 stores therein the distributed ledger. The distributed ledger stored in ledger storage 12 stores one or more transaction data items, and is managed using features of hash values, for instance, so that manipulation is difficult (this will be described later). Ledger storage 12 stores transaction data provided by processor 11 into the distributed ledger. The distributed ledger stores past to current transaction data items.

Such transaction data items are managed so as not to be manipulated, based on a feature that information recorded in a distributed ledger is difficult to be manipulated.

Note that the distributed ledger is a blockchain, for example, and such a case is described as an example. Yet it is possible to adopt a distributed ledger according to another technique (such as IOTA or Hashgraph, for example). Note that the distributed ledger may be or may not be a ledger for which consensus algorithm (for example, Practical Byzantine Fault Tolerance (PBFT), Proof of Work (PoW), or Proof of Stake (PoS)) is executed when new data is stored. An example of distributed ledger technology in which consensus algorithm is not executed is Hyperledger Fabric.

Executor 13 is a functional unit that executes processing with reference to transaction data stored in the distributed ledger stored in ledger storage 12. Executor 13 can be acquired by the processing unit (a CPU, for example) included in ledger server 10A executing a program using memory. Here, the case in which executor 13 is a contract executor that executes processing in accordance with smart contract code included in transaction data stored in the distributed ledger is to be described as an example.

Specifically, after the first transaction data is stored into the distributed ledger, executor 13 executes storing processing of reading out the first information included in the first transaction data stored in the distributed ledger, and storing the first information into storage 14. The storing processing is performed by executor 13 executing the first contract code included in the first transaction data, in response to the first transaction data being stored into the distributed ledger, for example.

Further, after the second transaction data is stored into the distributed ledger, executor 13 executes storing processing of reading out the second information included in the second transaction data stored in the distributed ledger, and storing the second information into storage 14. The storing processing is performed by executor 13 executing the second contract code included in the second transaction data, in response to the second transaction data being stored into the distributed ledger, for example.

Further, after the third transaction data is stored into the distributed ledger, executor 13 executes storing processing of reading out the third information included in the third transaction data stored in the distributed ledger, and storing the third information into storage 14. The storing processing is performed by executor 13 executing the third contract code included in the third transaction data, in response to the third transaction data being stored into the distributed ledger, for example.

Storage 14 is a storage device that includes a storage region storing information on contracts. Examples of information stored in storage 14 include first information, second information, and third information, specifically. The information stored in storage 14 is set and read out by executor 13. Storage 14 is acquired using a rewritable storage device, examples of which include memory such as random access memory (RAM), a hard disk drive (HDD), and a solid state drive (SSD).

Note that multi-signature (multisig) technology for giving a plurality of signatures may be applied to the first transaction data, the second transaction data, and the third transaction data, and this case will be described as an example, but a single digital signature may be given to the first transaction data, the second transaction data, and the third transaction data.

Specifically, the first transaction data may include digital signatures of company A and company B that are the contractors of the material contract. In that case, in storing the first transaction data into the distributed ledger, processor 11 stores the first transaction data into the distributed ledger when the digital signatures of company A and company B included in the first transaction data are both successfully verified.

Similarly, the second transaction data may include digital signatures of company A and company C that are the contractors of the manufacturing contract. In that case, in storing the second transaction data into the distributed ledger, processor 11 stores the second transaction data into the distributed ledger when the digital signatures of company A and company C included in the second transaction data are both successfully verified.

Similarly, the third transaction data may include digital signatures of transaction server 10T that is a user who has generated the material delivery contract and company B and company C that are contractors of the material delivery contract. In that case, in storing the third transaction data into the distributed ledger, processor 11 stores the third transaction data into the distributed ledger when the digital signatures of transaction server 10T, company B, and company C included in the third transaction data are all successfully verified.

Note that the first contract, the second contract, and the third contract can be expressed as below. Specifically, the first contract includes a contract that stipulates that the first user is to purchase the material from the second user. The first information includes a purchase price of the material. The second contract includes a contract that stipulates that the third user is to manufacture a product from the material delivered from the second user, and deliver the product to the first user. The second information includes a purchase price of the product, a deadline for delivering the product, and a delivery destination of the product. The third contract includes a contract that stipulates that the second user is to deliver the material to the third user. The third information includes the deadline for delivering the material and the delivery destination of the material.

The following describes transaction data and code for a smart contract.

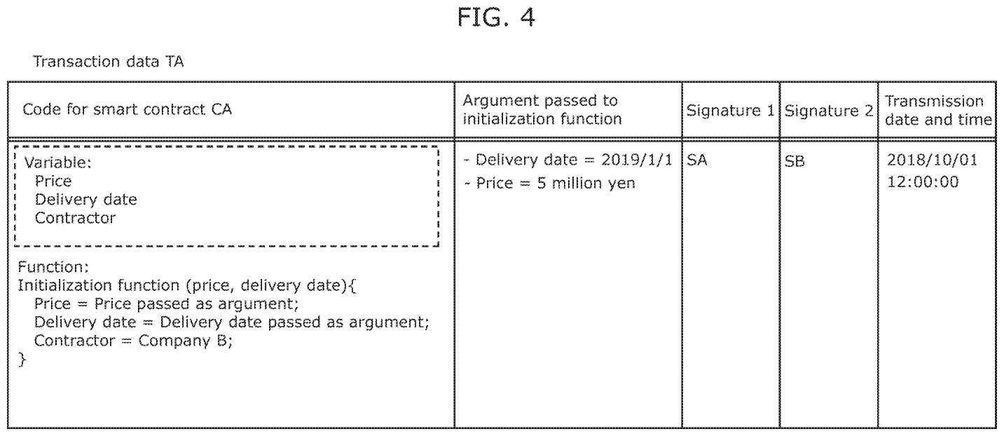

FIG. 4 is an explanatory drawing illustrating transaction data TA that is a first example of transaction data in the present embodiment. Transaction data TA corresponds to first transaction data. Transaction data TA is generated by ledger server 10A, for example.

As illustrated in FIG. 4, transaction data TA includes “Code for smart contract CA”, “Argument passed to initialization function”, “Signature 1”, “Signature 2”, and “Transmission date and time”.

“Code for smart contract CA” includes a variable portion indicating variables used by smart contract CA and stored in storage 14. The variable portion is shown by the broken line frame in FIG. 4. The same expression is also used in the following. The variables used by smart contract CA include a price, a delivery date, and a contractor. The price indicates the amount of money company A pays in the material contract. The delivery date indicates the deadline by which company B is to deliver the material to the material delivery destination. The contractor indicates a contractor of the material contract and in particular here, indicates a party different from company A out of the two parties that have made the material contract.

Further, “Code for smart contract CA” includes an initialization function. The initialization function is a special function that is executed by executor 13 when the transaction data is stored into a distributed ledger. The same also applies hereinafter.

The initialization function receives a price and a delivery date as arguments. Further, if the initialization function is executed, the initialization function assigns values to the variable indicating a price, the variable indicating a delivery date, and the variable indicating a contractor, which are stored in storage 14. Specifically, if the initialization function is executed, the initialization function sets the variable indicating a price to the price received as an argument, sets the variable indicating a delivery date to the delivery date received as an argument, and the variable indicating a contractor to the identification information of company B. Note that the identification information of company B may also be simply referred to as company B. The same also applies to company A and company C. The same also applies hereinafter.

Note that equivalent advantageous effects can be achieved also in the case in which the function shown as the initialization function in FIG. 4 is a general function (or in other words, not the initialization function), and the general function is executed using transaction data TA. The same also applies to an initialization function included in code for another smart contract.

“Argument passed to initialization function” is an argument that is passed to the initialization function in smart contract CA, and includes the delivery date (Jan. 1, 2019) and the price (5 million yen). Information items indicated as the arguments are passed to the initialization function.

“Signature 1” is the first one of two digital signatures given to transaction data TA. Signature 1 includes signature SA of company A.

“Signature 2” is the second one of the two digital signatures given to transaction data TA. Signature 2 includes signature SB of company B.

“Transmission date and time” indicates the date and time at which transaction data TA is transmitted. “2018/10/01 12:00:00” is stored in “Transmission date and time”.

When transaction data TA shown in FIG. 4 is stored into the distributed ledger, by the initialization function being executed, the variables indicating the price and the delivery date in storage 14 are set to the price and the delivery date, respectively, passed to the initialization function as arguments, and the variable indicating a contractor of the material contract in storage 14 is set to identification information of company B.

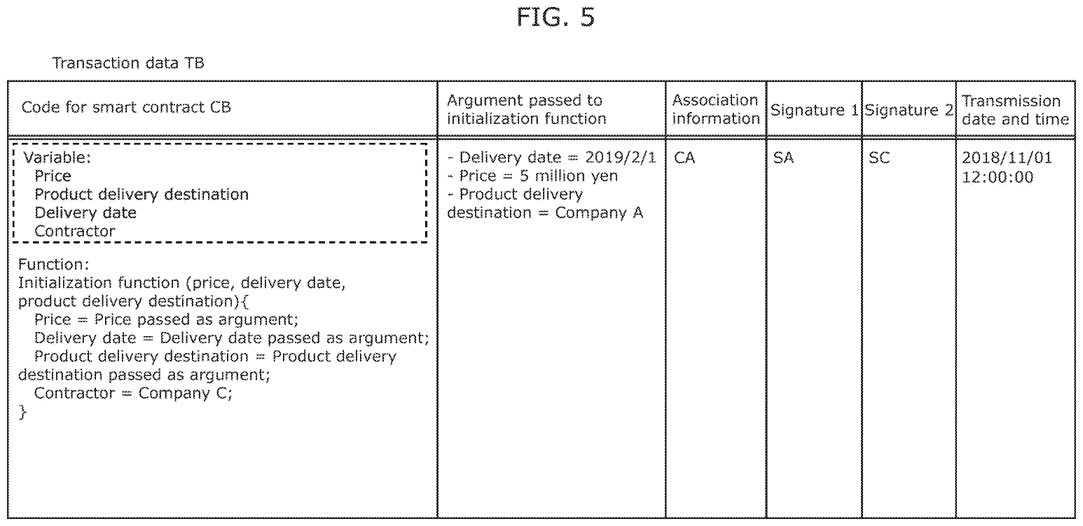

FIG. 5 is an explanatory drawing illustrating transaction data TB that is a second example of transaction data in the present embodiment. Transaction data TB corresponds to second transaction data. Transaction data TB is generated by ledger server 10A, for example.

As illustrated in FIG. 5, transaction data TB includes “Code for smart contract CB”, “Argument passed to initialization function”, “Association information”, “Signature 1”, “Signature 2”, and “Transmission date and time”.

“Code for smart contract CB” includes a variable portion and an initialization function. The variables used by smart contract CB include a price, a product delivery destination, a delivery date, and a contractor. The price indicates the amount of money company A pays in the manufacturing contract. The product delivery destination indicates the delivery destination of a product manufactured by company C under the manufacturing contract. The delivery date indicates the deadline by which company C is to deliver the product to the product delivery destination. The contractor indicates a contractor of the manufacturing contract and in particular here, indicates a party different from company A out of the two parties that have made the manufacturing contract.

The initialization function receives a price, a delivery date, and a product delivery destination as arguments. Further, if the initialization function is executed, the initialization function assigns values to the variable indicating a price, the variable indicating a product delivery destination, the variable indicating a delivery date, and the variable indicating a contractor, which are stored in storage 14. Specifically, if the initialization function is executed, the initialization function sets the variable indicating a price to the price received as an argument, sets the variable indicating a delivery date to the delivery date received as an argument, sets the variable indicating a product delivery destination to the product delivery destination received as an argument, and sets the variable indicating a contractor to identification information of company C.

“Argument passed to initialization function” is an argument that is passed to the initialization function in smart contract CB, and includes the delivery date (Feb. 1, 2019), the price (5 million yen), and the product delivery destination (identification information of company A). Information items indicated as the arguments are passed to the initialization function.

“Association information” indicates a smart contract associated with smart contract CB (or transaction data TB) and corresponding to the material contract. Association information includes information indicating smart contract CA.

“Signature 1” is the first one of two digital signatures given to transaction data TB. Signature 1 includes signature SA of company A.

“Signature 2” is the second one of the two digital signatures given to transaction data TB. Signature 2 includes signature SC of company C.

“Transmission date and time” indicates the date and time at which transaction data TB is transmitted. “2018/11/01 12:00:00” is stored in “Transmission date and time”.

When transaction data TB shown in FIG. 5 is stored into the distributed ledger, by the initialization function being executed, the variables indicating the delivery date, the price, and the product delivery destination in storage 14 are set to the delivery date, the price, and the product delivery destination, respectively, passed to the initialization function as arguments, and also sets the variable indicating a contractor to identification information of company C.

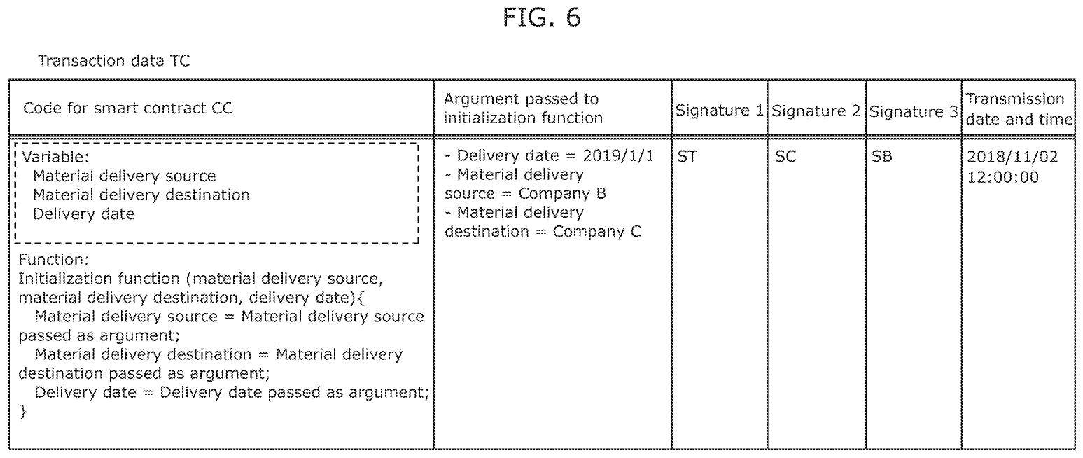

FIG. 6 is an explanatory drawing illustrating transaction data TC that is a third example of transaction data in the present embodiment. Transaction data TC corresponds to third transaction data. Transaction data TC is generated by transaction server 10T.

As illustrated in FIG. 6, transaction data TC includes “Code for smart contract CC”, “Argument passed to initialization function”, “Signature 1”, “Signature 2”, “Signature 3”, and “Transmission date and time”.

“Code for smart contract CC” includes a variable portion and an initialization function. The variables used by smart contract CC include a material delivery source, a material delivery destination, and a delivery date. The material delivery source indicates a delivery source of the material manufactured by company B in the material delivery contract. The material delivery destination indicates the delivery destination of the material manufactured by company B in the material delivery contract. The delivery date indicates the deadline by which company B is to deliver the material to the material delivery destination.

The initialization function receives the material delivery source, the material delivery destination, and the delivery date as arguments. Further, if the initialization function is executed, the initialization function assigns values to the variable indicating a material delivery source, the variable indicating a material delivery destination, and the variable indicating a delivery date, which are stored in storage 14. Specifically, if the initialization function is executed, the initialization function sets the variable indicating a material delivery source to the material delivery source received as an argument, sets the variable indicating a material delivery destination to the material delivery destination received as an argument, and sets the variable indicating a delivery date to the delivery date received as an argument.

“Argument passed to initialization function” is an argument that is passed to the initialization function in smart contract CC, and includes the delivery date (Jan. 1, 2019), the material delivery source (identification information of company B), and the material delivery destination (identification information of company C). Information items indicated as the arguments are passed to the initialization function.

“Signature 1” is the first one of three digital signatures given to transaction data TC. Signature 1 includes signature ST of transaction server 10T.

“Signature 2” is the second one of the three digital signatures given to transaction data TC. Signature 2 includes signature SC of company C.

“Signature 3” is the third one of the three digital signatures given to transaction data TC. Signature 3 includes signature SB of company B.

“Transmission date and time” indicates the date and time at which transaction data TC is transmitted. “2018/11/02 12:00:00” is stored in “Transmission date and time”.

When transaction data TC shown in FIG. 6 is stored into the distributed ledger, by the initialization function being executed, the variables indicating the material delivery source, the material delivery destination, and the delivery date in storage 14 are set to the material delivery source, the material delivery destination, and the delivery date, respectively, passed to the initialization function as arguments.

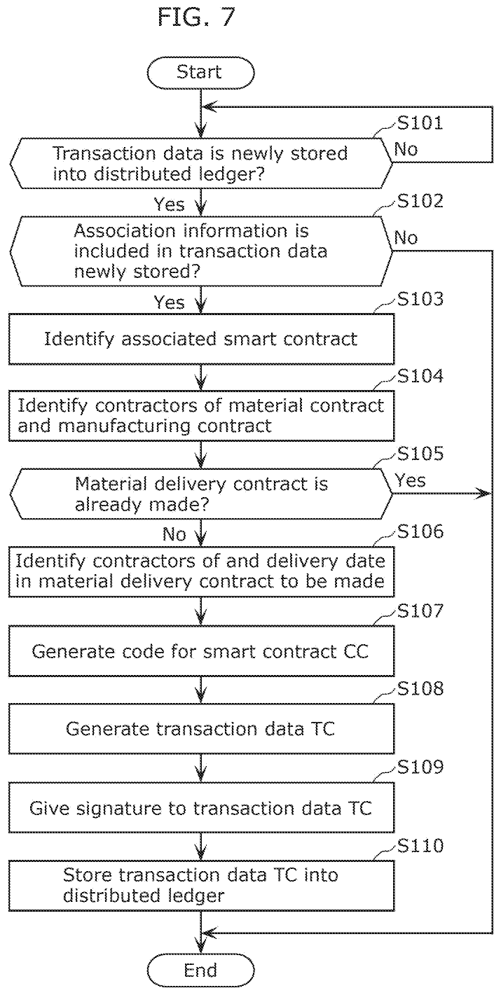

FIG. 7 is a flowchart illustrating processing performed by transaction server 10T in the present embodiment. The flowchart illustrated in FIG. 7 illustrates processing performed by transaction server 10T to generate and store transaction data TC into the distributed ledger.

In step S101, processor 11 of transaction server 10T determines whether transaction data is newly stored into the distributed ledger that ledger storage 12 has. When transaction data is determined to be newly stored (Yes in step S101), the processing proceeds to step S102. Otherwise (No in step S101), step S101 is executed again. Thus, processor 11 waits in step S101 until transaction data is newly stored.

In step S102, processor 11 of transaction server 10T determines whether the transaction data newly stored into the distributed ledger includes association information. Here, when transaction data newly stored into the distributed ledger includes a smart contract corresponding to the manufacturing contract, the transaction data includes association information. If association information is determined to be included (Yes in step S102), the processing proceeds to step S103. Otherwise (No in step S102), the series of processes illustrated in FIG. 7 ends.

In step S103, with reference to association information included in transaction data newly stored into the distributed ledger, processor 11 of transaction server 10T identifies a smart contract that is associated therewith (also referred to as an associated smart contract). For example, when transaction data TB illustrated in FIG. 5 is newly stored into the distributed ledger, processor 11 identifies smart contract CA corresponding to the material contract as the associated smart contract.

In step S104, processor 11 of transaction server 10T identifies contractors of the material contract and the manufacturing contract. The material contract corresponds to the smart contract identified in step S103. The manufacturing contract corresponds to a smart contract included in the transaction data determined to be newly stored into the distributed ledger in step S101. For example, when the transaction data corresponding to the material contract is transaction data TA (see FIG. 4)) and the transaction data corresponding to the manufacturing contract is transaction data TB (see FIG. 5), company B and company C are identified as contractors of the material contract and the manufacturing contract. About the delivery of the material manufactured by company B to company C, that is, the material manufactured by company B, the material delivery source is identified to be company B and the material delivery destination is identified to be company C.

In step S105, processor 11 of transaction server 10T determines whether the material delivery contract is already made between company B and company C that are the contractors identified in step S104. More specifically, processor 11 determines whether the material delivery contract that stipulates that the material is to be delivered from company B to company C is already made. If the material delivery contract is determined to be already made (Yes in step S105), the series of processes illustrated in FIG. 7 ends. Otherwise (No in step S105), the processing proceeds to step S106.

In step S106, processor 11 of transaction server 10T identifies the contractors who are to make the material delivery contract and the delivery date to be stipulated in the material delivery contract. In the case of the example in step S104 as above, the contractors are identified as company B and company C, and more specifically, the material delivery source is identified as company B and the material delivery destination is identified as company C. The delivery date is determined to be a date that is a predetermined period before the delivery date of the product in the manufacturing contract, and is determined to be, for example, Jan. 1, 2019, that is one month, which is a predetermined period, before the delivery date of the product that is Feb. 1, 2019. The predetermined period is determined based on a period necessary for manufacturing a material, for example.

In step S107, processor 11 of transaction server 10T generates code for smart contract CC corresponding to the material delivery contract that is to be made between the contractors identified in step S108.

In step S108, processor 11 of transaction server 10T generates transaction data TC that includes the code for smart contract CC generated in step S107. The material delivery source and the material delivery destination in “Argument passed to initialization function” in transaction data TC are set to company B that is the material delivery source and company C that is the material delivery destination identified in step S106, respectively.

In step S109, processor 11 of transaction server 10T gives a signature to transaction data TC generated in step S108. Transaction data TC to which transaction server 10T has given the signature is transmitted to ledger server 10C, and is given a signature of ledger server 10C. After that, transaction data TC is transmitted to ledger server 10B, is given a signature of ledger server 10B, and thereafter is transmitted to ledger servers 10A and 10C and transaction server 10T.

In step S110, processor 11 of transaction server 10T stores transaction data TC to which the signatures are given in step S109 into the distributed ledger. At this time, each of ledger servers 10A to 10C also stores transaction data TC into the distributed ledger. Accordingly, the distributed ledgers of ledger servers 10A to 10C and transaction server 10T are all in a state in which transaction data TC is stored.

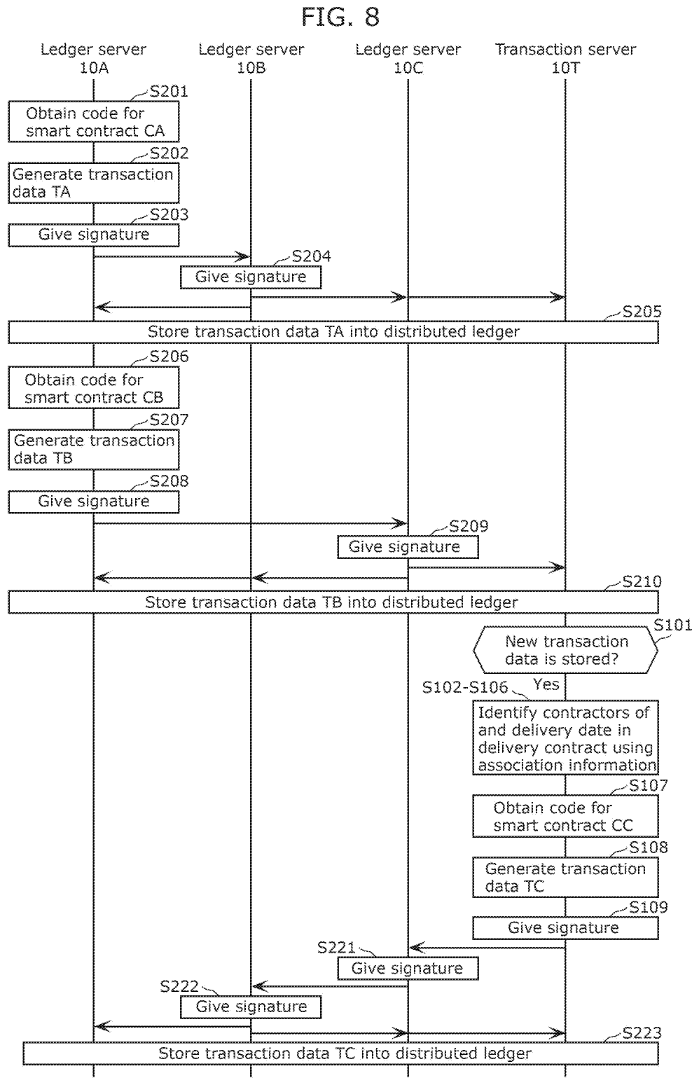

FIG. 8 is a first sequence diagram illustrating processing in contract management system 1 in the present embodiment. FIG. 8 illustrates a series of processes related to making a material contract, making a manufacturing contract and making a material delivery contract. In FIG. 8, processes same as the processes illustrated in FIG. 7 are given the same numerals, and a detailed description thereof is omitted.

In step S201, processor 11 of ledger server 10A obtains code for smart contract CA corresponding to the material contract. The code for smart contract CA may be obtained by ledger server 10A generating the code or by ledger server 10A receiving the code transmitted from terminal 20A in response to an operation made by a person in charge of company A.

In step S202, processor 11 of ledger server 10A generates transaction data TA. Transaction data TA generated includes the code for smart contract CA obtained in step S201 (see FIG. 4).

In step S203, processor 11 of ledger server 10A generates a signature for transaction data TA generated in step S202, gives the signature to transaction data TA, and transmits transaction data TA having the signature to ledger server 10B.

In step S204, processor 11 of ledger server 10B receives transaction data TA transmitted in step S203, generates a signature for transaction data TA received, gives the signature to transaction data TA, and transmits transaction data TA having the signatures to each of ledger servers 10A and 10C and transaction server 10T. Accordingly, all of ledger servers 10A to 10C and transaction server 10T are in a state of having transaction data TA to which the signatures of ledger servers 10A and 108 are given.

In step S205, each of ledger servers 10A to 10C and transaction server 10T stores (transmitted) transaction data TA to which the signature is additionally given in step S204, into the distributed ledger. In storing transaction data TA into the distributed ledgers, transaction data TA may be stored into the distributed ledgers under a condition that ledger servers 10A to 10C and transaction server 10T reach agreement based on consensus algorithm.

In step S206, processor 11 of ledger server 10A obtains code for smart contract CB corresponding to the manufacturing contract. The code for smart contract CB may be obtained by ledger server 10A generating the code or by ledger server 10A receiving the code transmitted from terminal 20A in response to an operation made by a person in charge of company A.

In step S207, processor 11 of ledger server 10A generates transaction data TB. Transaction data TB generated includes the code for smart contract CB obtained in step S206 (see FIG. 5).

In step S208, processor 11 of ledger server 10A generates a signature for transaction data TB generated in step S207, gives the signature to transaction data TB, and transmits transaction data TB having the signature to ledger server 10C.

In step S209, processor 11 of ledger server 10C receives transaction data TB transmitted in step S208, generates a signature for transaction data TB received, gives the signature to transaction data TB, and transmits transaction data TB having the signatures to each of ledger servers 10A and 10B and transaction server 10T. Accordingly, all of ledger servers 10A to 10C and transaction server 10T are in a state of having transaction data TB to which the signatures of ledger servers 10A and 10C are given.

In step S210, each of ledger servers 10A to 10C and transaction server 10T stores (transmitted) transaction data TB to which the signature is additionally given in step S209, into the distributed ledger. In storing transaction data TB into the distributed ledgers, transaction data TB may be stored into the distributed ledgers under a condition that ledger servers 10A to 10C and transaction server 10T reach agreement based on consensus algorithm.

Processor 11 of transaction server 10T determines that new transaction data is stored, based on transaction data TB being stored into the distributed ledger in step S210 (Yes in step S101), obtains smart contract CC corresponding to the material delivery contract, and generates and transmits transaction data TC to ledger server 10C (steps S102 to S109).

In step S221, processor 11 of ledger server 10C receives transaction data TC transmitted in step S109, generates a signature for transaction data TC received, gives the signature to transaction data TC, and transmits transaction data TC having the signatures to ledger server 10B.

In step S222, processor 11 of ledger server 10B receives transaction data TC transmitted in step S221, generates a signature for transaction data TC received, gives the signature to transaction data TC, and transmits transaction data TC having the signatures to each of ledger servers 10A and 10C and transaction server 10T. Accordingly, all of ledger servers 10A to 10C and transaction server 10T are in a state of having transaction data TC to which the signatures of transaction server 10T and ledger servers 10A and 10C are given.

In step S223, each of ledger servers 10A to 10C and transaction server 10T stores (transmitted) transaction data TC to which the signature is additionally given in step S222, into the distributed ledger. In storing transaction data TC into the distributed ledgers, transaction data TC may be stored into the distributed ledgers under a condition that ledger servers 10A to 10C and transaction server 10T reach agreement based on consensus algorithm.

Note that the signatures given to transaction data TC may include at least the signature of transaction server 10T. In this case, at least one of ledger servers 10B and 10C does not need to give a signature to received transaction data TC.

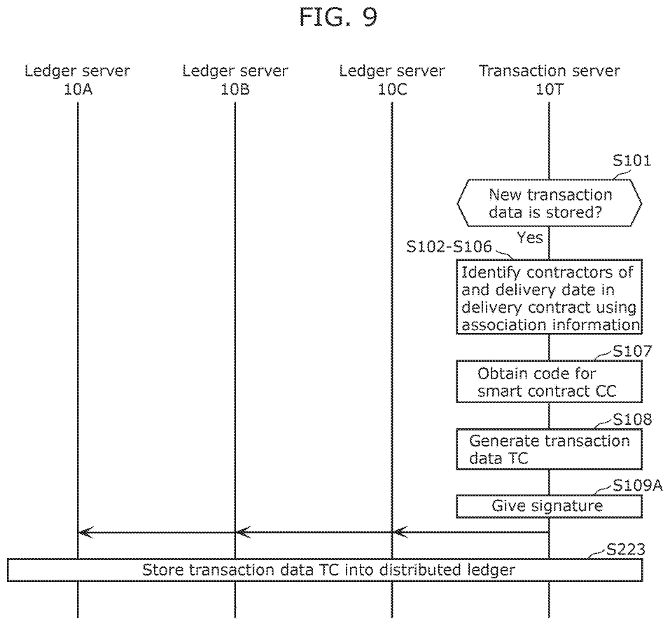

For example, FIG. 9 illustrates an example of a sequence diagram in a case in which ledger servers 10B and 10C both do not give signatures. FIG. 9 illustrates processing in step S101 and thereafter in FIG. 8. In step S109A in FIG. 9, processor 11 of transaction server 10T transmits transaction data TC to which the signature is give to ledger servers 10A, 10B, and 10C. After that, in step S223, each of ledger servers 10A to 10C and transaction server 10T stores transaction data TC into the distributed ledger.

Through the series of processes illustrated in FIG. 8 and FIG. 9, contract management system 1 can cause company B and company C to make a new material delivery contract without a person being involved, based on the content of the material contract made between company A and company B and the content of the manufacturing contract made between company A and company C. Accordingly, contract management system 1 can reduce an increase in power consumption of a computer system that manages contracts, while appropriately managing contracts in which company A, company B, and company C are involved.

Note that in the above, the case in which association information is included in transaction data TB is described as an example, yet association information may be included in transaction data TA. In this case, after transaction data TB is stored into the distributed ledger, an associated smart contract is identified.

### Embodiment 2

The present embodiment describes, for instance, a contract management system that reduces an increase in power consumption of a computer system that manages contracts and a control method of the contract management system, focusing on a different aspect from Embodiment 1.

Contract management system 2 in the present embodiment contributes to generation of a new contract between contractors who have made both of the earlier two contracts Note that in the present embodiment, transaction server 10T is not used to manage contracts.

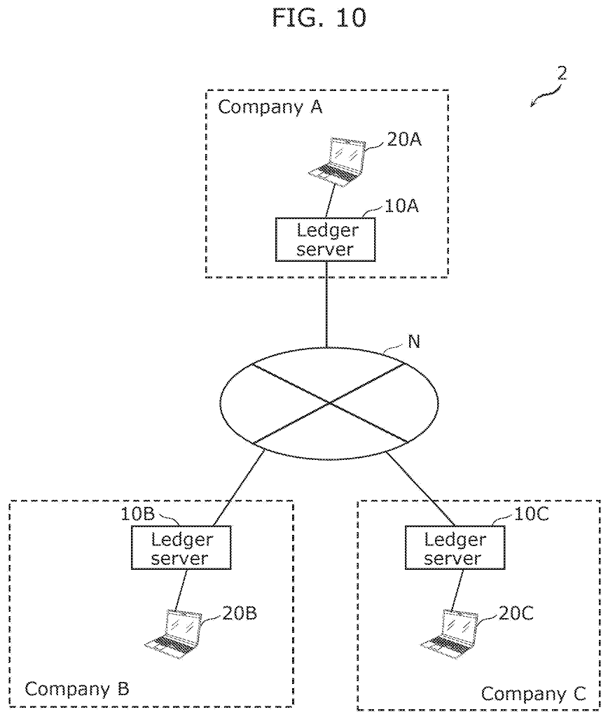

FIG. 10 is a block diagram schematically illustrating a configuration of contract management system 2 in the present embodiment.

As illustrated in FIG. 10, contract management system 2 does not include transaction server 10T included in contract management system 1 in Embodiment 1. The other configuration is the same as contract management system 1.

Technology of executing processing of obtaining third transaction data, based on information designated by a user (corresponding to the first user, that is, company A) who is a contractor of the first contract and a contractor of the second contract in contract management system 2 is to be described.

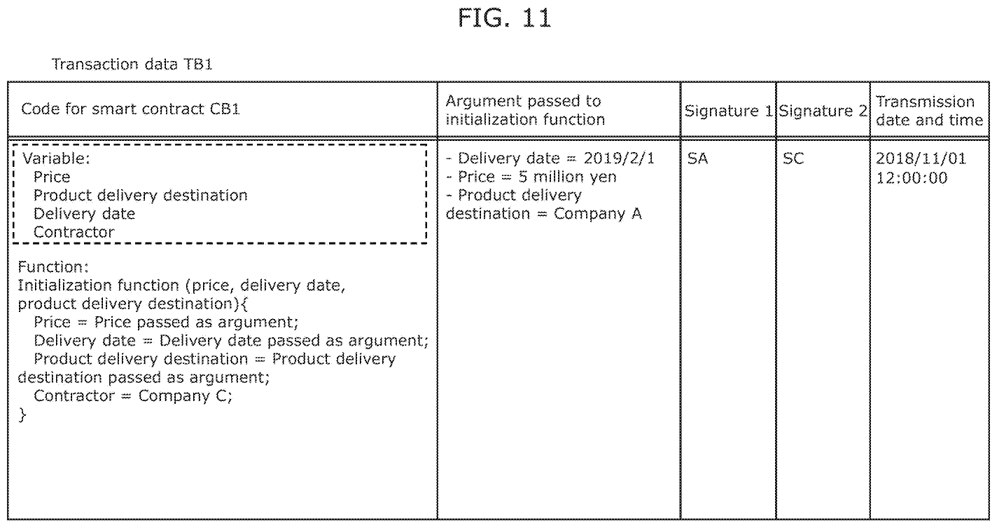

FIG. 11 is an explanatory drawing illustrating transaction data TB1 that is a first example of transaction data in the present embodiment.

Transaction data TB1 is similar to transaction data TB in Embodiment 1 (see FIG. 5), but is different therefrom in that association information is not included. The other points are the same as transaction data TB. Transaction data TB1 corresponds to second transaction data.

Note that code for a smart contract included in transaction data TB1 is referred to as code for smart contract CB1.

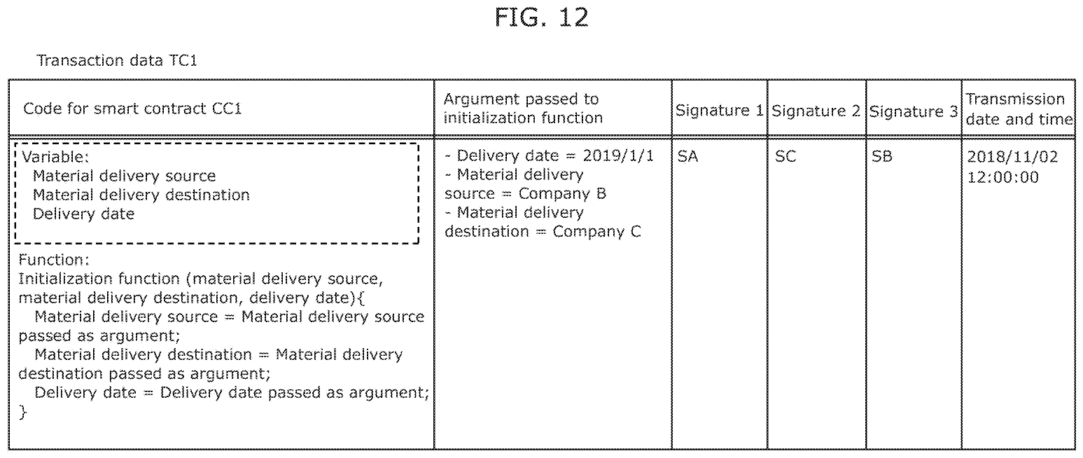

FIG. 12 is an explanatory drawing illustrating transaction data TC1 that is a second example of transaction data in the present embodiment.

Transaction data TC1 is similar to transaction data TC in Embodiment 1 (see FIG. 6), but is different therefrom in that the signature of company A is included in “Signature 1”. The other points are the same as transaction data TC. Transaction data TC1 corresponds to third transaction data.

Note that code for a smart contract included in transaction data TC1 is referred to as code for smart contract CC1.

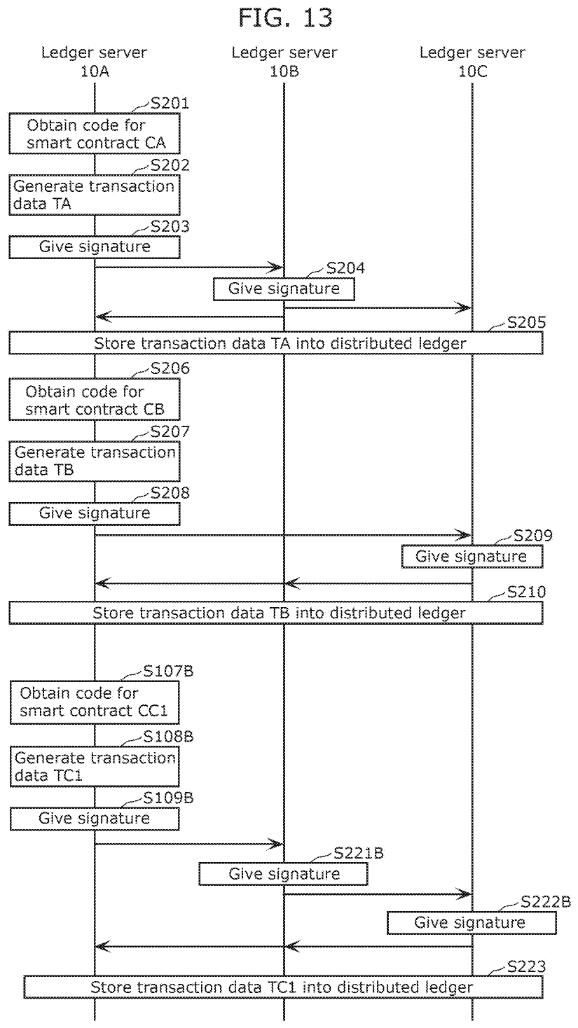

FIG. 13 is a sequence diagram illustrating processing in contract management system 2 in the present embodiment. FIG. 13 illustrates a series of processes related to making a material contract, making a manufacturing contract and making a material delivery contract, similarly to FIG. 8 in Embodiment 1. In FIG. 13, processes same as the processes in FIG. 8 are given the same numerals, and a detailed description thereof is omitted.

Steps S201 to S210 illustrated in FIG. 13 is the same as the processing in Embodiment 1. In steps S201 to S210, transaction data TA that includes smart contract CA corresponding to the material contract made between company A and company B is stored into the distributed ledgers, and transaction data TB that includes smart contract CB corresponding to the manufacturing contract made between company B and company C is stored into distributed ledgers.

In step S107B, processor 11 of ledger server 10A generates code for smart contract CC1 corresponding to the material delivery contract.

In step S108B, processor 11 of transaction server 10A generates transaction data TC1 that includes the code for smart contract CC1 generated in step S107B. The material delivery source and the material delivery destination in “Argument passed to initialization function” in transaction data TC1 are determined based on information designated by company A, that is a contractor of the material contract and a contractor of the manufacturing contract. For example, company B that is the one who is to manufacture material and deliver the material in the material contract is identified as the material delivery source, and company C that is the one who is to manufacture a product from the material in the manufacturing contract is identified as the material delivery destination.

In step S109B, processor 11 of transaction server 10T gives a signature to transaction data TC1 generated in step S108B, and transmits transaction data TC1 to which the signature is given to ledger server 10B, similarly to step S109.

In step S221B, processor 11 of ledger server 10B receives transaction data TC1 transmitted in step S109B, generates a signature for transaction data TC1 received, gives the signature to transaction data TC1, and transmits transaction data TC1 having the signatures to ledger server 10C.

In step S222B, processor 11 of ledger server 10C receives transaction data TC1 transmitted in step S221B, generates a signature for transaction data TC1 received, gives the signature to transaction data TC1, and transmits transaction data TC1 having the signatures to each of ledger servers 10A and 10B. Accordingly, all ledger servers 10A to 10C1 are in a state of having transaction data TC1 to which the signatures of ledger servers 10A to 10C are given.

In step S223, each of ledger servers 10A to 10C stores (transmitted) transaction data TC1 to which the signature is additionally given in step S222B, into the distributed ledger. In storing transaction data TC1 into the distributed ledgers, transaction data TC1 may be stored into the distributed ledgers under a condition that ledger servers 10A to 10C reach agreement based on consensus algorithm.

Through the series of processes illustrated in FIG. 13, contract management system 2 can cause company B and company C to make a new material delivery contract without a person being involved and without using a transaction server, based on the content of the material contract made between company A and company B and the content of the manufacturing contract made between company A and company C.

Accordingly, contract management system 2 can reduce an increase in power consumption of a computer system that manages contracts, while appropriately managing contracts in which company A, company B, and company C are involved.

### Variation 1

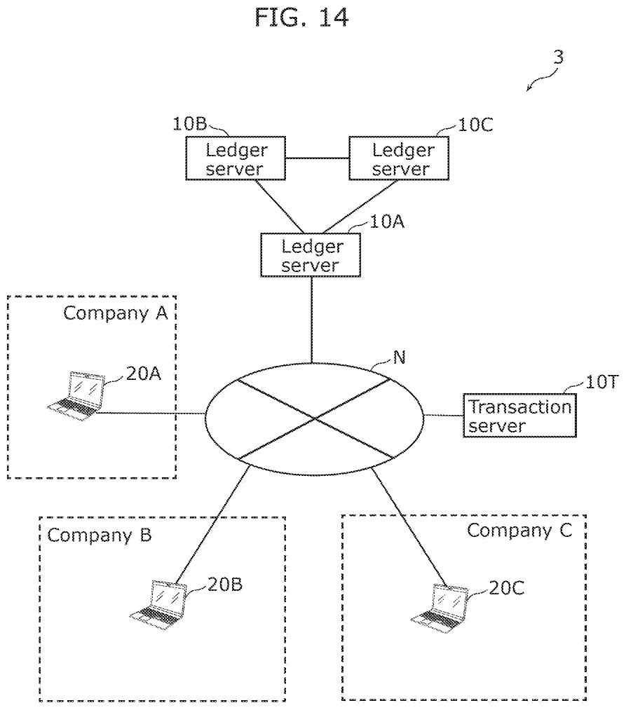

FIG. 14 is a block diagram schematically illustrating a configuration of contract management system 3 in this variation. Contract management system 3 in this variation is a variation of contract management system 1 in Embodiment 1.

Contract management system 3 illustrated in FIG. 14 includes ledger servers 10A, 10B, and 10C, terminals 20A, 20B, and 20C, and transaction server 10T.

In contract management system 3, ledger servers 10A, 10B, and 10C are collectively disposed in a single location. More generally, ledger servers 10A, 10B, and 10C are not necessarily disposed in company A, company B, and company C, respectively, and may be disposed in any locations where direct or indirect connection to network N is possible.

Such disposition of ledger servers 10A to 10C may achieve similar functions and yield similar advantageous effects to those of contract management system 1 in Embodiment 1.

### Variation 2

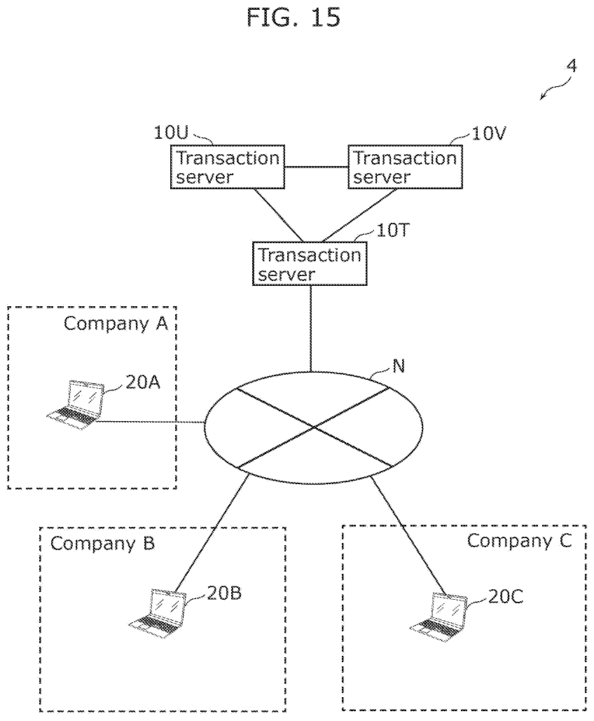

FIG. 15 is a block diagram schematically illustrating a configuration of contract management system 4 in this variation. Contract management system 4 in this variation is a variation of contract management system 1 in Embodiment 1.

Contract management system 4 illustrated in FIG. 15 includes transaction servers 10T, 10U, and 10V, and terminals 20A, 20B, and 20C.

In contract management system 4, transaction server 10T, 10U, and 10V (also referred to as transaction servers 10T to 10V) also have the functions of ledger servers 10A, 10B, and 10C. Note that transaction servers 10T, 10U, and 10V are collectively disposed in a single location similarly to ledger servers 10A to 10C in Variation 1, but may be disposed in company A, company B, and company C, respectively, as in Embodiment 1.

Such disposition of transaction servers 10T to 10V may achieve similar functions and yield similar advantageous effects to those of contract management system 1 in Embodiment 1.

### Supplement

Blockchains in the above embodiments and variations are to be supplementally described.

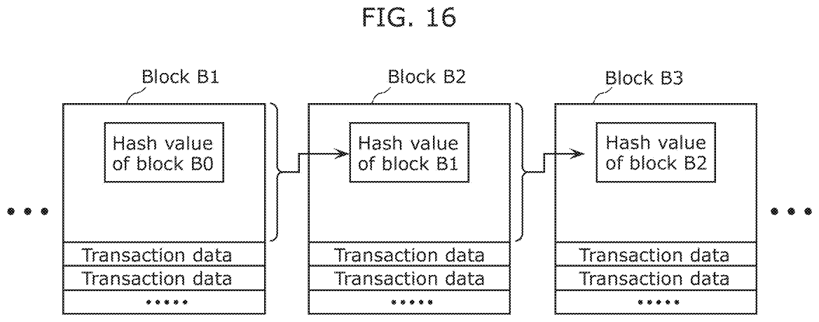

FIG. 16 is an explanatory drawing illustrating a data structure of a blockchain.

A blockchain is formed into a chain constituted by connecting blocks that are recording units. Each block includes a plurality of transaction data items and a hash value of a previous block. Specifically, block B2 includes a hash value of previous block B1. A hash value calculated from a plurality of transaction data items included in block B2 and the hash value of block B1 is included in block B3 as a hash value of block B2. In this manner, blocks are connected into a chain with the content of a previous block being included as a hash value, so that manipulation of recorded transaction data is effectively prevented.

If past transaction data is changed, the hash value of a block becomes different from the value before being changed. Thus, in order to make the manipulated block appear valid, it is necessary to recreate all the blocks after the manipulated block, and this work is extremely difficult from the practical view. Difficulty in manipulation of a blockchain is ensured using such a feature.

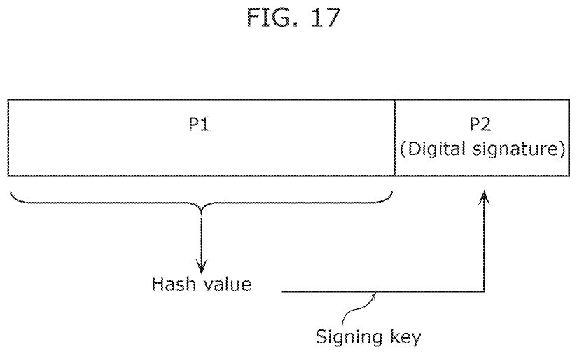

FIG. 17 is an explanatory drawing illustrating a data structure of transaction data.

Transaction data illustrated in FIG. 17 includes transaction body P1 and digital signature P2. Transaction body P1 is a data body included in the transaction data. Digital signature P2 is generated by adding a signature to the hash value of transaction body P1 using a signing key of a creator of the transaction data, or more specifically, by encrypting data using the signing key of the creator.

Transaction data has digital signature P2, and thus it is substantially impossible to manipulate such transaction data. Accordingly, manipulation of a transaction body can be prevented.

Note that in the above embodiments, each of the elements may be acquired using dedicated hardware, or may be obtained by executing a software program suitable for the element. Each element may be acquired by a program executor such as a CPU or a processor reading and executing a software program recorded on a recording medium such as a hard disk or semiconductor memory. Here, the software that acquires, for instance, the contract management system according to the above embodiments is a program as below.

Thus, this program causes a computer to execute a control method executed by a device out of a plurality of devices each having a distributed ledger in a contract management system that includes the plurality of devices, the control method including: obtaining first transaction data that includes first information on a first contract made between a first user and a second user; storing the first transaction data obtained into the distributed ledger; obtaining second transaction data that includes second information on a second contract made between the first user and a third user; storing the second transaction data obtained into the distributed ledger; obtaining third transaction data using the first information and the second information, when one of the first transaction data and the second transaction data is associated with a remaining one of the first transaction data and the second transaction data, the third transaction data including third information on a third contract made between the second user and the third user; and storing the third transaction data obtained into the distributed ledger.

The above has given a description of the contract management system and others according to one or more aspects, based on the embodiments, yet the present disclosure is not limited to these embodiments. The scope of one or more aspects may also encompass embodiments as a result of adding, to the embodiments, various modifications that may be conceived by those skilled in the art, and embodiments obtained by combining elements in different embodiments, as long as the resultant embodiments do not depart from the gist of the present disclosure.

### INDUSTRIAL APPLICABILITY

The present disclosure is applicable to a contract management system that manages contracts.

1. A control method executed by a device out of a plurality of devices each having a distributed ledger in a contract management system that includes the plurality of devices, the control method comprising:
obtaining first transaction data that includes first information on a first contract made between a first user and a second user;
storing the first transaction data obtained into the distributed ledger;
obtaining second transaction data that includes second information on a second contract made between the first user and a third user;
storing the second transaction data obtained into the distributed ledger;
obtaining third transaction data using the first information and the second information, when one of the first transaction data and the second transaction data is associated with a remaining one of the first transaction data and the second transaction data, the third transaction data including third information on a third contract made between the second user and the third user; and
storing the third transaction data obtained into the distributed ledger.

2. The control method according to claim 1,
wherein in obtaining the third transaction data,
whether a condition is satisfied is determined, the condition indicating that one of the first transaction data and the second transaction data is associated with a remaining one of the first transaction data and the second transaction data, and
when the condition is determined to be satisfied, the third transaction data is obtained by being generated.

3. The control method according to claim 2,
wherein the second transaction data includes association information indicating that the second transaction data is associated with the first transaction data, and
in determining whether the condition is satisfied, the condition is a condition that the second transaction data includes the association information.

4. The control method according to claim 1,
wherein in obtaining the third transaction data, the third transaction data is obtained based on information designated by the first user, the first user being a contractor of the first contract and a contractor of the second contract.

5. The control method according to claim 1,
wherein the first transaction data includes first contract code that includes the first information.

6. The control method according to claim 1,
wherein the second transaction data includes second contract code that includes the second information.

7. The control method according to claim 1,
wherein the third transaction data includes third contract code that includes the third information.

8. The control method according to claim 1,
wherein the first transaction data includes a digital signature of the first user and a digital signature of the second user, and
in storing the first transaction data into the distributed ledger, the first transaction data is stored into the distributed ledger when the digital signature of the first user and the digital signature of the second user that are included in the first transaction data are both successfully verified.

9. The control method according to claim 1,
wherein the second transaction data includes a digital signature of the first user and a digital signature of the third user, and
in storing the second transaction data into the distributed ledger, the second transaction data is stored into the distributed ledger when the digital signature of the first user and the digital signature of the third user that are included in the second transaction data are both successfully verified.

10. The control method according to claim 1,
wherein the third transaction data includes a digital signature of a generation user who has generated the third transaction data, a digital signature of the second user, and a digital signature of the third user, and
in storing the third transaction data into the distributed ledger, the third transaction data is stored into the distributed ledger when the digital signature of the generation user, the digital signature of the second user, and the digital signature of the third user that are included in the third transaction data are all successfully verified.

11. The control method according to claim 1,
wherein the first contract includes a contract that stipulates that the first user is to purchase material from the second user,
the first information includes a purchase price of the material,
the second contract includes a contract that stipulates that the third user is to manufacture a product from the material delivered from the second user, and deliver the product to the first user,
the second information includes a purchase price of the product, a deadline by which the product is to be delivered, and a delivery destination of the product,
the third contract includes a contract that stipulates that the second user is to deliver the material to the third user, and
the third information includes a deadline by which the material is to be delivered and a delivery destination of the material.

12. A device out of a plurality of devices each having a distributed ledger in a contract management system that includes the plurality of devices, the device comprising:
a processor;
a ledger storage that stores therein the distributed ledger; and
an executor,
wherein the processor:
obtains first transaction data that includes first information on a first contract made between a first user and a second user;
stores the first transaction data obtained into the distributed ledger;
obtains second transaction data that includes second information on a second contract made between the first user and a third user; and
stores the second transaction data obtained into the distributed ledger,
the executor generates third transaction data using the first information and the second information, when one of the first transaction data and the second transaction data is associated with a remaining one of the first transaction data and the second transaction data, the third transaction data including third information on a third contract made between the second user and the third user, and
the processor further stores the third transaction data generated into the distributed ledger.

13. A non-transitory computer-readable recording medium having recorded thereon a program for causing a computer to execute the control method according to claim 1.
